(19) United States
(12) Patent Application Publication
(10) Pub. No.: US 2021/0318951 A1
(43) Pub. Date: Oct. 14, 2021

(54) Translation of Embedded Software API's for Carrying Out Software Testing

(71) Applicant: SATIXFY ISRAEL LTD., Rehovot (IL)

(72) Inventor: Doron GOMBOSH, Ramat Efal (IL)

(21) Appl. No.: 17/270,673

(22) PCT Filed: Aug. 22, 2019
(86) PCT No.: PCT/IL2019/050943

§ 371 Date: Feb. 23, 2021

Related U.S. Application Data
(60) Provisional application No. 62/722,193, filed on Aug. 24, 2018.

(51) Int. Cl. G06F 11/36; H04L 29/06

(52) U.S. Cl. CPC G06F 11/3696; G06F 11/3664; H04L 67/40

(57) ABSTRACT

When starting the validation process of a product containing embedded software, a scripting language is usually used to write the ramp-up and validation tests. These tests must make use of the embedded APIs within the embedded software which the product runs. Using such a procedure usually requires a much-needed layer of translation between the APIs and the scripting language functions, both in the documentation aspect, and the code aspect. The present solution discloses a method for carrying out a validation process of a product that comprises embedded software, characterized in that a translation layer is automatically implemented to enable linkage between the APIs and the scripting language function, which can save time and minimize human errors while carrying out the process.

### FIELD OF THE DISCLOSURE

The present disclosure generally relates to the field of embedded software and more particularly, to methods for handling APIs that are included within embedded software.

### BACKGROUND OF THE DISCLOSURE

As embedded systems requirements keep growing while development cycles shrink, developers increasingly integrate commercial application programming interfaces (APIs), or collections of functions that the software tool publisher provides for utilizing the tool's features within an application.

When starting a validation process of a product containing embedded software, a scripting language is usually used to write the ramp-up and validation tests. These tests must make use of the embedded APIs that are comprised within the embedded software which is executed by the product. This procedure usually requires a much-needed layer of translation between the APIs and the scripting language functions, both in the documentation aspect, and in the code aspect.

Today, the translation of embedded software APIs for such a testing layer in a validation process of both software and hardware, is carried out manually.

It would therefore be advisable to find a method that enables saving time otherwise required for importing embedded software APIs to the testing layer, thereby enabling the user to focus on the actual test writing procedure on the one hand, while eliminating human errors that might occur when such a process is carried out manually.

### SUMMARY OF THE DISCLOSURE

The disclosure may be summarized by referring to the appended claims.

It is an object of the present disclosure to provide a method for carrying out a validation process of a product that comprises embedded software.

It is another object of the present disclosure to provide a method wherein the validation process of a product that comprises embedded software, is carried out while implementing a translation layer between the APIs and the scripting language function.

Other objects of the present invention will become apparent from the following description.

According to a first embodiment of the present disclosure, there is provided a method for carrying out a validation process of a product that comprises embedded software, characterized in that a translation layer is automatically implemented to link between APIs and a scripting layer.

In accordance with another embodiment, the process is carried out at the translation layer, and comprises the steps of:

a) booting/loading the embedded software;
b) requesting instructions for the translation layer (scripting);
c) receiving the requested instructions and generating one or more software codes for the translation layer's functions according to the instructions provided; and
d) loading the new software code on top of an existing scripting layer.

By yet another embodiment, wherein upon executing that process, one or more new sets of functions are added to become a part of the scripting layer.

In accordance with still another embodiment, the method further comprising a step of translating the translation layer's functions into scripting language's constructs.

According to another embodiment, if a datatype which exists in the embedded software's language does not exist in the scripting layer's language, that datatype will be converted into an appropriate different datatype.

By still another embodiment, if one or more input/output parameters of the API function are not used and are not required by the scripting layer, that one or more input/output parameters will be hidden for the translation process.

In accordance with yet another embodiment, at least one of the translated functions contains a debugging feature.

According to another embodiment, the method provided further comprises a step of adding a wrapper code over the API functions and performing a more complex operation therewith.

According to still another embodiment the process is automatically executed when a validation environment is uploaded, thereby allowing carrying out automated tests which rely on translation layer's functions.

According to another embodiment, the method further comprises automatically updating the scripting layer by implementing thereat changes associated with API functions.

In accordance with another embodiment the process is initiated when the scripting layer accesses the API layer in order to retrieve required information therefrom.

### BRIEF DESCRIPTION OF THE DRAWINGS

For a more complete understanding of the present invention, reference is now made to the following detailed description taken in conjunction with the accompanying drawings wherein:

FIG. 1 illustrates the flow of a testing procedure carried out for a chip being tested, wherein the procedure is carried out according to an embodiment construed in accordance with the present invention; and

FIG. 2 is a block diagram of an example of components of the system for carrying the testing methods in accordance with an embodiment of the present invention.

### DETAILED DESCRIPTION OF THE DISCLOSURE

In this disclosure, the term “comprising” is intended to have an open-ended meaning so that when a first element is stated as comprising a second element, the first element may also include one or more other elements that are not necessarily identified or described herein, or recited in the claims.

In the following description, for the purposes of explanation, numerous specific details are set forth in order to provide a better understanding of the present invention by way of examples. It should be apparent, however, that the present invention may be practiced without these specific details.

An embedded software (firmware) can publish its APIs to the testing layer on a “per demand” basis. The format of the published APIs is printed in a pre-defined syntax, and/or comprises the testing layer's language code snippets. The term “snippet” as used herein is a programming term for a small region of re-usable source code, machine code, or text. Ordinarily, these are formally defined operative units to incorporate into larger programming modules.

Generally speaking, the procedure to which the present disclosure relates, comprises two major parts. The first being the “Instructions function” of the embedded software, and the second—the “Translation function” in the scripting layer.

The actual process (“Translation”) comprises the following steps:

1) Booting/loading the embedded software;
2) Requesting the instructions for the Translate (scripting) layer;
3) Generating a software code for the Translate layer's functions according to the instructions provided; and
4) Loading the new software code on top of the existing scripting environment.

Thus, at the end of the acquisition process described above, one or more new sets of functions are available as a part of the scripting layer.

The translated functions are translated into the scripting language's constructs.

Certain rules may be applied while carrying out the process. For example: if a datatype which exists in the embedded language does not exist in the scripting language, is will be converted into an appropriate datatype. Another example, if some of the input/output parameters of the API function are not used and are not required in the scripting layer, they may be hidden by the translation process.

The translated functions may also contain debugging features in order to assist the user and hopefully to improve the productivity of the validation process (for example: more verbose over the API's function). Another option could be adding one or more wrapper codes over the API functions and use them to perform more complex operations (e.g. by using more input/output parameters than the API, or even calling a few sub-API functions from the top translated function).

According to the solution provided by the present invention, this process is automatically executed when the validation environment is uploaded, thereby, allowing carrying out automated tests while relying on these translation functions.

The advantage of using the automated process is further enhanced in cases such as when a new software version is embedded and this new version results in changes occurring in the behavior of the API (i.e. input/output parameters) or in adding/removing API functions. By applying the solution of the present invention, these changes will be automatically updated in the scripting layer.

The process itself may be initiated by the scripting layer accessing the API layer in order to retrieve the required information therefrom.

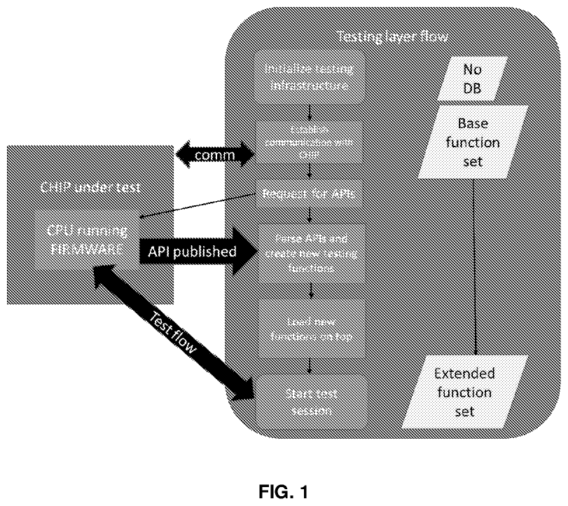

FIG. 1 illustrates the flow process of the testing layer as well as the status of its function “Data Base” during operation. At the initialization stage of a testing session, the testing layer requests and parses the API snippets, thereby generating actual testing layer language functions, while embedding the information and/or code snippets from the published APIs in the functions that will be used in the test procedure. These functions are then loaded on top of the running test session, thus extending the testing layer to support those functions under real time conditions.

When the process begins, the function “database” starts from scratch (No DB), and after the initialization stage, it comprises a set of the basic functions. As the process proceeds, it will comprise an extended set of functions that includes those functions that were meanwhile imported from the embedded software.

Any change in the firmware is automatically translated into a change in the testing layer, thereby preventing human errors that might occur during transfer of information from the software engineer to the testing engineer.

Let us now consider in more details the process described herein.

### Embedded Software:

The embedded software language can be any language if the scripting layer can interact with it at the textual level (i.e. sending and receiving strings to/from the embedded layer). The operating system (OS) on which the embedded software is running, must be able to bridge the gap that exists between the software APIs and the scripting language (which is a typical requirement of any validation platform). The communication protocol can be any applicable protocol, depending on the available HW connections and the required performance rate (e.g. SSH, serial socket, SPI, I2C over ethernet, UART, PCIe etc.).

### Scripting Layer:

The scripting layer can use any applicable language, while in some languages implementing the translation function might be somewhat more complicated than others.

The recommended language for carrying out the translation is Python, since it usually runs in an interpreted mode, and since the modules are being loaded dynamically, it is therefore a preferred choice for an acquisition process that needs to load new functions/modules on top of the existing ones.

### Implementation:

### Embedded Software:

At the embedded side, the implementation may be carried out by two methods:

### 1) Pre-Defined Template:

In this case, there is a consent between the embedded and scripting layers regarding a pre-defined “syntax” for the translation instructions.

### Example

<function name>:<parameter1 type>=<parameter1 name>,<parameter2 type>=<parameter2 name>, . . . :<output1 type>=<output1 name>,<output2 type>=<output2 name>, . . . :<comment/help string for function>

The character indicates separation between different parts, and the character “,” indicates inner separation of the parameters within such a part. This helps the translation function (scripting layer) to parse the information.

The implementation is done in this example by writing a function which returns this syntax line per API function which needs to be translated. This function can also be used as a “help” function for the software APIs.

2) Embedded Scripting Language Code within the Instructions:

In this advanced mode, the scripting language that is being used should be known in advance, and the code (or a part of the code) for the translation is returned by the instructions function. It should be noted that adopting this method of implementation involves a greater security risk, as the API function can exploit the machine running the validation scripts by putting malicious code in the instructions function. However, since this process is usually carried out only for internal use, the security risk is not that significant.

### Example (Simplified)

void Instructions_func( )
{
printf(“def Api1(param1, param2) : \n
Ret=COMM(‘API_ONE(param1, param2)’) \n return Ret”);
}

The printout of the instructions function is derived from a python code. This code is executed by the scripting layer to add a new function. The result would be a new function in the scripting layer called “Api1” which calls the API function “API_ONE” and returns the outputs. The “COMM” function is the implementation of the communication protocol in the scripting layer, to enable communication with the validated product (e.g. evaluation board, etc.).

This type of implementation simplifies the translation layer but on the other hand complicates the instructions function.

There is also an implementation option where a combination of the above methods 1 and 2 is used.

### Scripting Layer:

The scripting layer should call the instructions function to get the string(s) of instructions. In case that the first method is implemented, the instructions string will be parsed, and a new function code will be constructed and executed. In case that the second method is implemented, the instructions string will be executed as is.

The following example demonstrates an embodiment of carrying out the first method disclosed according to an embodiment of the present invention.

### Example for Implementing Method #1:

def import_api_functions(self,):

ret_str=“ ”

functions_arr=[ ]

api_command_re=re.compile(“.*cli command -(\w+)[\t]*;[\t]*args -(.*);[\t]*(.*)$”,re.DOTALL)

instruction_lines=api_instructions( )

for line in instruction_lines:
re_detected=api_command_re.match(line)
if re_detected:
   api_cmd_name=re_detected.group(1).strip( )
   if api_cmd_name in
rtos_uart.ignored_api_functions:
   continue
   api_cmd_param_str=
re_detected.group(2).strip( )
   if api_cmd_param_str:
      api_cmd_param_str=[i.strip( ) for i in
   api_cmd_param_str.split(“,”)]
   api_cmd_help=re_detected.group(3).strip( )
   ret_str+=

(self.exec_api_function_def(api_cmd_name,api_cmd_param_str,api_cmd_help))
functions_arr.append(api_cmd_name)
info(“Loaded cli functions:
% s”,str(functions_arr))
return ret_str
   def gen_api_functions_file(self):

api_file=open(“api_functions.py”,“w”)

try:
api_file.write(self.import_api_functions( )

except:
error(“Could not load API_FUNCTIONS, please check your instructions format”)

api_file.close( )

def main( ):

gen_api_functions_file( )

import api_functions

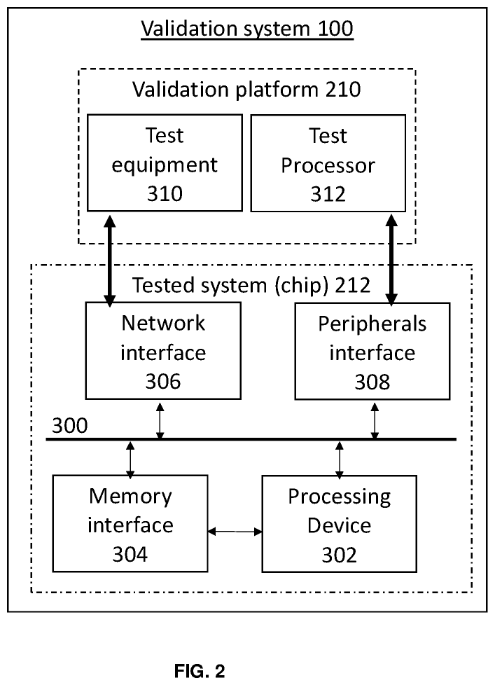

FIG. 2 is a block diagram of an example of components of the system for carrying the embodiments disclosed hereinabove. In one embodiment, the system may include a bus 300 (or other communication mechanism) that interconnects subsystems and components for transferring information within system 100. For example, bus 300 may interconnect a processing device 302, a memory device 304, a network interface 306, and a peripherals' interface 308 connected to validation platform system processor I/O interface 312. Processing device 302, shown in FIG. 2, may include at least one processor configured to execute computer programs, applications, methods, processes, or other software to perform embodiments described in the present disclosure.

The term “processing device” refers to any physical device having an electric circuit that performs a logic operation. For example, the processing device may include one or more integrated circuits, microchips, microcontrollers, microprocessors, all or part of a central processing unit (CPU), graphics processing unit (GPU), digital signal processor (DSP), field programmable gate array (FPGA), or other circuits suitable for executing instructions or performing logic operations. The processing device may include at least one processor configured to perform functions of the disclosed methods such as a microprocessor manufactured by Intel™ or by AMD™, ARC, MIPS or other. The processing device may include a single core or multiple core processors executing parallel processes simultaneously. In one example, the processing device may be a single core processor configured with virtual processing technologies. In another example, the processing device may include a multiple-core processor arrangement (e.g., dual, quad core, etc.) configured to provide parallel processing functionalities to allow a device associated with the processing device to execute multiple processes simultaneously. It is appreciated that other types of processor arrangements could be implemented to provide the capabilities disclosed herein.

Processing device 302 may use memory device 304 to access data and a software product stored on the memory device (e.g. an embedded software). Memory device 304 may include high-speed random access memory and/or non-volatile memory such as one or more magnetic disk storage devices, one or more optical storage devices, and/or flash memory (e.g., NAND, NOR). Memory device 304 may store an operating system, such as LINUX, iOS, UNIX, OS X, WINDOWS, or an embedded operating system such as VXWorkS. The operating system can include instructions for handling basic system services and for performing hardware dependent tasks.

As used herein, a non-transitory computer-readable storage medium refers to any type of physical memory on which information or data readable by at least one processor can be stored. Examples include random access memory (RAM), read-only memory (ROM), volatile memory, nonvolatile memory, hard drives, CD ROMs, DVDs, flash drives, disks, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The terms “memory” and “computer-readable storage medium” may refer to multiple structures, such as a plurality of memories or computer-readable storage mediums located within system 100, or at a remote location. Additionally, one or more computer-readable storage mediums can be utilized in implementing a computer-implemented method. The term “computer-readable storage medium” should be understood to include tangible items and exclude carrier waves and transient signals.

In some embodiment, the system may include network interface 306 coupled to bus 300 that is configured to provide a two-way data communication to a communications network. In one embodiment, network interface 306 may include an asymmetric digital subscriber line (ADSL) card, cable modem, or a satellite modem. As another example, network interface 306 may include a local area network (LAN) card to provide a data communication connection to a compatible LAN. In another embodiment, network interface 306 may include an Ethernet port connected to radio frequency receivers and transmitters and/or optical (e.g., infrared) receivers and transmitters. The specific design and implementation of network interface 306 depends on the communications network(s) over which the system is intended to operate. The network interface 306 may be connected in turn to some form of testing equipment 310, which is a part of the validation platform 210, to enable checking and validating the network behavior of the tested system 212. The testing equipment is able to report the findings to the test processor 312, in order to move the testing session forward and provide pass/fail indication.

The system may also include peripherals interface 308 coupled to bus 300. Peripherals interface 308 may be connected to devices and subsystems to facilitate multiple functionalities, namely the validation operation functionality. In one embodiment, peripherals interface 308 may be connected to I/O port of the validation platform 210 configured to receive signals or input from devices and providing signals or output to one or more devices that allow data to be received and/or transmitted by the tested system 212 (e.g. retrieving data to be used while executing the algorithm disclosed herein). In one example, the validation platform 210 may include a touch screen controller, and/or other input controller(s). In addition, validation platform 210 may include a display screen (e.g., CRT or LCD) in place of the touch screen.

While the preferred embodiment and various alternative embodiments of the invention have been disclosed and described in detail herein, it may be apparent to those skilled in the art that various changes in form and detail may be made therein without departing from the spirit and scope thereof.

1. A method for carrying out a validation process of a product that comprises embedded software, characterized in that a translation layer is automatically implemented to link between the APIs and the scripting language function.

2. The method of claim 1, wherein a process is carried out at said translation layer, wherein said process comprises the steps of:
a) booting/loading the embedded software;
b) requesting instructions for the translation layer;
c) receiving the requested instructions and generating one or more software codes for the translation layer's functions according to the instructions provided; and
d) loading the new software code on top of an existing scripting layer.

3. The method of claim 2, wherein upon executing said process, one or more new sets of functions are added to become a part of said scripting layer.

4. The method of claim 2, further comprising a step of translating the translation layer's functions into scripting language's constructs.

5. The method of claim 2, wherein if a datatype which exists in the embedded software's language does not exist in the scripting layer's language, said datatype will be converted into an appropriate different datatype.

6. The method of claim 5, wherein if one or more input/output parameters of the API function are not used and are not required by the scripting layer, said one or more input/output parameters will be hidden for the translation process.

7. The method of claim 2, wherein at least one of the translated functions contains a debugging feature.

8. The method of claim 2, further comprising a step of adding a wrapper code over the API functions and performing a more complex operation therewith.

9. The method of claim 1, wherein said process is automatically executed when a validation environment is uploaded.

10. The method of claim 1, further comprising automatically updating said scripting layer by implementing thereat changes associated with API functions.

11. The method of claim 1, wherein said process is initiated when the scripting layer accesses the API layer in order to retrieve required information therefrom.
